(19) United States
(12) Patent Application Publication
(10) Pub. No.: US 2007/0134474 A1
(43) Pub. Date: Jun. 14, 2007

(54) COLOR FILTER LAYER HAVING COLOR DECISION LAYER, IMAGE SENSING DEVICE HAVING THE SAME, AND METHOD OF FORMING COLOR FILTER LAYER

(76) Inventors: Jung-Chak Ahn, Suwon-si (KR); Bum-suk Kim, Seoul (KR); Yun-ho Jang, Seoul (KR); Sae-young Kim, Seoul (KR)

Correspondence Address: Frank Chau, Esq.;F. CHAU & ASSOCIATES, LLC, 130 Woodbury Road, Woodbury, NY, 11797, US

(21) Appl. No.: 11/608,674

(22) Filed: Dec. 8, 2006

(30) Foreign Application Priority Data
Dec. 13, 2005 (KR) 10-2005-0122551

(51) Int. Cl. B32B 7/02

(52) U.S. Cl. 428/212

(57) ABSTRACT

A color filter layer for use in an image sensing device includes first inorganic layers, each first inorganic layer having a first refractive index, and second inorganic layers, each second inorganic layer having a second refractive index, wherein the second refractive index is higher than the first refractive index, wherein the first and second inorganic layers are stacked on an optical sensor provided in the image sensing device to form a multi-layer, and the multi-layer includes fixed thickness layers each having a fixed thickness and a color decision layer having a thickness determined according to a wavelength band of light to be passed.

### CROSS-REFERENCE TO RELATED PATENT APPLICATION

This application claims priority to Korean Patent Application No. 10-2005-0122551, filed on Dec. 13, 2005, the disclosure of which is incorporated herein in its entirety by reference.

### BACKGROUND OF THE INVENTION

1. Technical Field

The present disclosure relates to an image sensing device including a color filter layer having a color decision layer, and more particularly, to a color filter layer formed by alternately stacking thin inorganic layers having different refractive indexes on a photodiode.

2. Discussion of the Related Art

Image sensors used for portable phone cameras and digital cameras include complementary metal oxide semiconductor (CMOS) image sensors and [charged] charge coupled devices (CCDs). The image sensors receive an image and output corresponding image signals.

FIG. 1 shows a conventional CMOS image sensor. The CMOS image sensor includes a module lens 110 for condensing light and a chip 120 for generating an image signal that corresponds to incident light. The chip 120 includes an image pixel region 130 having image pixels, a black pixel region 140 (or optical black region) having black pixels for removing an error generated by offset or heat, a row driver 160 driving pixels in units of a row, and an analog-to-digital converter 150 for converting an analog image signal from pixels in each column into digital image data.

FIG. 2 is a view illustrating the structure of image pixels provided in the image pixel region 130 of FIG, 1. One red (R) pixel and one green (G) pixel are illustrated in FIG. 2. Each pixel of FIG. 2 includes a silicon substrate 202, a photodiode PDr or PDg 204, an antireflection coating (ARC) layer 205, a first metal line 206 and a second metal line 208 constituting a pixel circuit, an interlayer insulation layer 207, a color filter (R or G) 210, and a microlens 209.

Light condensed by the module lens 110 (of FIG. 1) and the microlens 209 is filtered by the color filter 210, passes through the interlayer insulation layer 207 and the antireflection coating 205, and strikes the photodiode 204. The photodiode 204 generates a photo charge that corresponds to the amount of incident light.

The color filter 210 is formed by stacking different organic materials depending on the [light] color to be passed. The color filter 210 is formed directly under the microlens 209 with a sufficient thickness.

However, since the color filter 210 should have a sufficient thickness, it is difficult to form a color filter having a complicated pattern The color filter 210 comprises an organic material, which is vulnerable to heat. A separate operation is needed for the organic material in a semiconductor manufacturing process.

Further, since the color filter 210 is distant from the photodiode 204, the pixel including the color filter 210 is vulnerable to crosstalk. That is, light that has passed through the R color filter can reach the photodiode PDg as well as the photodiode PDr, and light that has passed through the G color filter can reach the photodiode PDr as well as the photodiode PDg, which causes the image sensor including the color filter 210 to output an erroneous image signal.

### SUMMARY OF THE INVENTION

According to an exemplary embodiment of the present invention, a color filter layer includes first inorganic layers each having a first refractive index and second inorganic layers each having a second refractive index, wherein the second refractive index is higher than the first refractive index, and wherein the first and second inorganic layers are stacked on an optical sensor provided in the image sensing device to constitute a multi-layer, and the multi-layer includes fixed thickness layers each having a fixed thickness and a color decision layer having a thickness determined according to a wavelength band of light to be passed.

The multi-layer may selectively pass tight in a particular wavelength band according to the color decision layer, and block light outside the particular wavelength band.

The color decision layer may be one of the first inorganic layers and the second inorganic layers.

The first inorganic layers and the second inorganic layers can be alternately stacked on the optical sensor to constitute the multi-layer.

The total thickness of the multi-layer may be determined such that the multi-layer can be an antireflection coating (ARC) layer for preventing reflection of incident light.

The optical sensor may be a photodiode, and the image sensing device may be a CMOS image sensor (CIS).

According to an exemplary embodiment of the present invention, an image sensing device includes a microlens condensing incident lights a color filter layer selectively passing light in a particular wavelength band, and a photodiode generating a photo charge that corresponds to the amount of incident light, wherein the color fitter layer is formed by alternately stacking first inorganic layers and second inorganic layers on a region where the photodiode is formed, each first inorganic layer having a first refractive index and each second inorganic layer having a second refractive index, wherein the second refractive index is higher than the first refractive index, wherein the color filter layer includes fixed thickness layers each having a fixed thickness and a color decision layer having a thickness determined according to the wavelength band of light to be passed.

According to an exemplary embodiment of the present invention, a method of forming a color filter layer of an image sensing device includes stacking a second inorganic layer having a thickness determined according to a wavelength band of light to be passed stacking a first inorganic layer having a fixed thickness regardless of the wavelength band of light to be passed and stacking a second inorganic layer having a fixed thickness regardless of the wavelength band of light to be passed, wherein the color filter layer is formed on a photodiode formed on a silicon substrate, and each second inorganic layer has a higher refractive index than that of each first inorganic layer.

According to an exemplary embodiment of the present invention, a method of forming a color filter layer of an image sensing device includes stacking a first inorganic layer having a fixed thickness regardless of a wavelength band of light to be passed, stacking a second inorganic layer having a fixed thickness regardless of the wavelength band of light to be passed, and stacking a first inorganic layer having a thickness determined according to the wavelength band of tight to be passed, wherein the color filter layer is formed on a photodiode formed on a silicon substrate, and each second inorganic layer has a higher refractive index than that of each first inorganic layer.

Since the color filter layer according to an exemplary embodiment of the present invention is thinner than a conventional organic color filter, the color filter layer can be formed into a complicated pattern. Since inorganic material is used in an exemplary embodiment of the present invention, the color filter is not influenced by external heat. An exemplary embodiment of the present invention does not require a separate operation of processing an organic material during a semiconductor process. Since the color filter layer according to an exemplary embodiment of the present invention is formed directly on a photodiode, crosstalk is prevented. Since only the thickness of a color decision layer of the color filter layer is changed to control the wavelength band, the wavelength band of light to be passed can be controlled.

### BRIEF DESCRIPTION OF THE DRAWINGS

Exemplary embodiments of the present disclosure can be understood in more detail from the following description taken in conjunction with the accompanying drawings in which:

FIG. 1 shows a conventional CMOS image sensor.

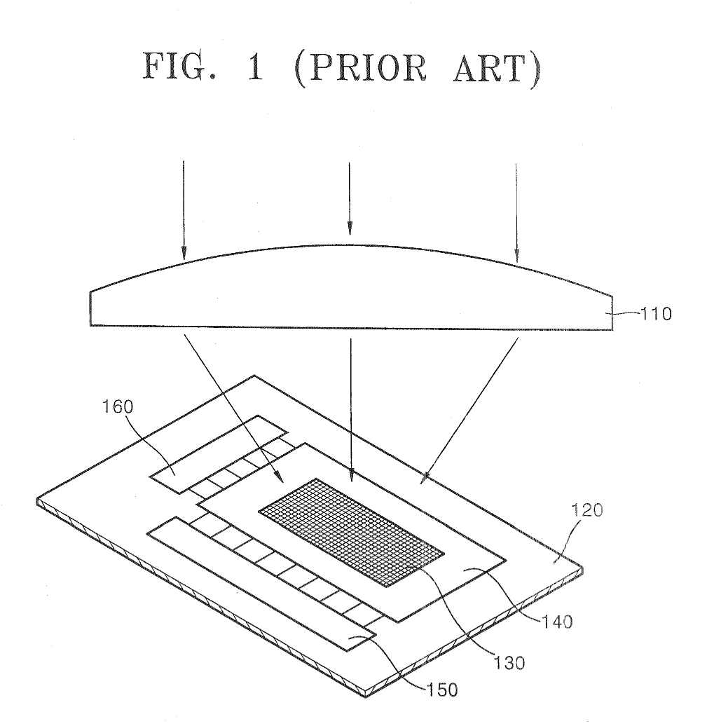

FIG. 2 is a view illustrating the structure of image pixels provided in the image pixel region 130 of FIG. 1;

FIG. 3 shows an image sensing device including a color filter layer according to an exemplary embodiment of the present invention;

FIG. 4 shows a table for illustrating a relation between a thickness and a refractive index for each layer, and a graph for illustrating a relation between a wavelength and transmittance when the color filter layer of FIG. 3 is a red color filter layer according to an exemplary embodiment of the present invention;

FIG. 5 shows a table for illustrating a relation between a thickness and a refractive index for each layer, and a graph for illustrating a relation between a wavelength and transmittance when the color filter layer of FIG. 3 is a green color filter layer according to an exemplary embodiment of the present invention;

FIG. 6 shows a table for illustrating a relation between a thickness and a refractive index for each layer, and a graph for illustrating a relation between a wavelength and transmittance when the color filter layer of FIG. 3 is a blue color filter layer according to an exemplary embodiment of the present invention; and

FIG. 7 is a graph showing a relation between a wavelength and transmittance according to an exemplary embodiment of the present invention.

### DETAILED DESCRIPTION OF EXEMPLARY EMBODIMENTS

Exemplary embodiments of the present invention will be described below in more detail with reference to the accompanying drawings. The present invention may be embodied in many different forms and should not be construed as limited to the embodiments set forth herein.

A color filter layer according to an exemplary embodiment of the present invention may be applied to a variety of image sensing devices such as, for example, a CMOS image sensor (CIS) including a photodiode optical sensor.

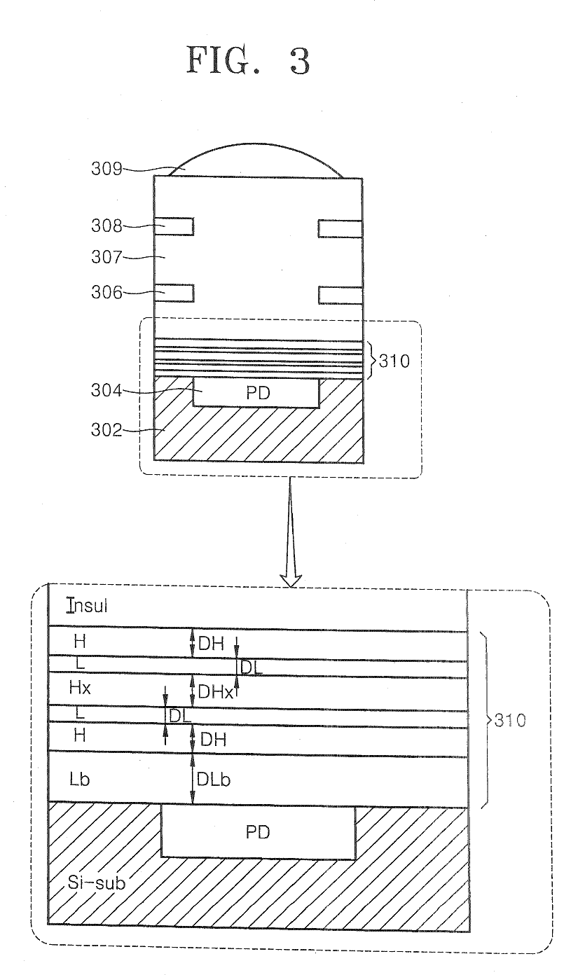

FIG. 3 shows an image sensing device including a color filter layer according to an exemplary embodiment of the present invention.

Referring to FIG. 3, the image sensing device includes a silicon substrate (Si-sub) 302, a photodiode (PD) 304, a color filter layer 310, a first metal line 306, a second metal line 308, an interlayer insulation layer 307, and a microlens 309. The PD 304 formed on the silicon substrate 302 generates a photo charge that corresponds to the amount of light that passes through the microlens 309, the interlayer insulation layer 307, and the color filter layer 310.

The first metal tine 306 and the second metal line 308 are provided within a pixel to facilitate a pixel circuit reading change in the PD 304. The microlens 309 condenses light, and the interlayer insulation layer 307 insulates the first metal layer 306 from the second metal layer 308. The color filter layer 310 according to an exemplary embodiment of the present invention is formed in a multi-layered structure. As shown in the lower diagram in FIG. 3, a multi-layer color filter layer 310 is formed by stacking a plurality of inorganic layers Lb, H, L, Hx, La and H.

The color filter layer 310 according to an exemplary embodiment of the present invention uses inorganic layers Lb, H, L, Hx, H each layer comprising an inorganic material. Since an inorganic material is used for the color filter 310 according to an exemplary embodiment of the present invention, the color filter 310 is not influenced by heat applied to the color filter 310, and a separate operation for processing an organic material is not required.

The color filter layer 310 according to an exemplary embodiment of the present invention includes first inorganic layers Lb and L and second inorganic layers Hx and H. Each of the second inorganic layers Hx and H has a refractive index higher than that of the first inorganic layers Lb and L. The first inorganic layers Lb and L and the second inorganic layers Hx and H are stacked on the PD 304 to constitute the multi-layer 310.

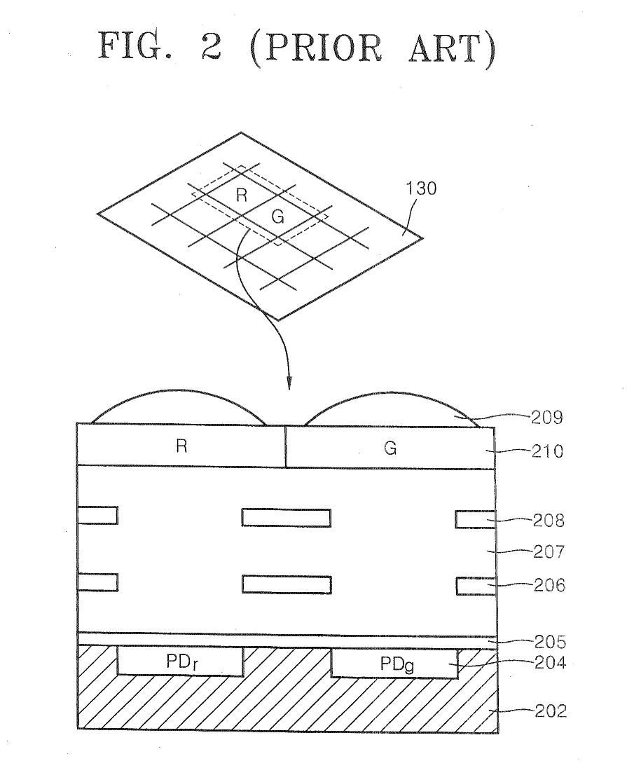

Since the color filter layer 210 of FIG. 2 is formed distant from the photodiode 204, and is formed directly under the microlens 209, the color filter layer 210 is vulnerable to crosstalk. However, since the color filter layer 310 according to an exemplary embodiment of the present invention is formed directly above the PD 304, the crosstalk can be prevented.

Each layer Lb, H, and L has a fixed thickness, and a color decision layer Hx has a thickness determined according to the wavelength band of light to be passed.

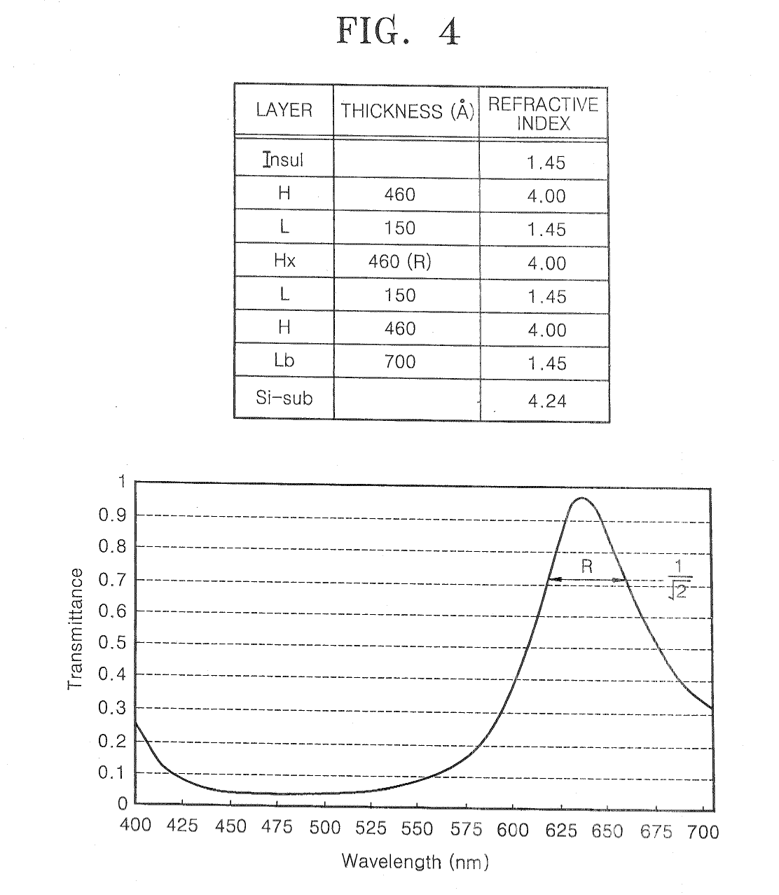

For example, when the color filter layer 310 according to an exemplary embodiment of the present invention is used for a red color filter layer, a green color filter layer, or a blue color filter layer, thicknesses of each of the fixed thickness layers Lb, H, and L do not change regardless of the particular color. (For example, see the tables of FIGS. 4, 5 and 6). The color decision layer Hx has a different thickness depending on whether the color filter layer 310 is used for the red color filter layer, the green color filter layer, or the blue color filter layer. The thickness of the color decision layer Hx is determined such that the color filter 310 selectively passes light (i.e. R, G, or B) in the particular wavelength band. The color filter layer 310 according to an exemplary embodiment of the present invention includes the color decision layer Hx, thereby selectively passing light (i.e. R, G, or B) in a particular wavelength band and blocking light other than light having the particular wavelength band.

Referring to FIG. 3, the color filter layer 310 includes the color decision layer formed of the second inorganic layer Hx. The color filter layer 310 according to an exemplary embodiment of the present invention includes fixed thickness layers Lb and L formed of the first inorganic layers, a fixed thickness layer formed of the second inorganic layer H, and a color decision layer formed of the second inorganic layer Hx.

The thicknesses DLb and DL of the fixed thickness layers Lb and L comprising the first inorganic layers, and the thickness DH of the fixed thickness layer comprising the second inorganic layer H are fixed regardless of a wavelength band of light for passing the color filter layer 310. The thickness DHx of the color decision layer comprising the second inorganic layer Hx is determined according to the wavelength band of light for passing the color filter layer 310.

According to an exemplary embodiment of the present invention, the color decision layer may alternatively be the first inorganic layer Lx. (Although not shown in FIG. 3, the first inorganic layer used as a color decision layer is referred to as “Lx” hereinafter). In this exemplary embodiment, the color filter layer 310 includes a fixed thickness layer comprising the first inorganic layer L, the color decision layer comprising the first inorganic layer Lx, and a fixed thickness layer comprising the second inorganic layer H.

As illustrated in FIG. 3, the first inorganic layers L and the second inorganic layers H are alternately stacked on a region where the PD 304 is formed, to constitute the multi-layer 310. Though a structure of sequentially stacking the inorganic layers starting from the first inorganic layer Lb is illustrated in FIG. 3, the color filter layer 310 may have a structure in which the inorganic layers are sequentially stacked starting from the second inorganic layer H according to an exemplary embodiment of the present invention.

Since the color filter layer 310 has a multi-layered structure, multiple interference, such as multiple constructive interference or multiple destructive interference, occurs when light passes through the color filter 310. The thickness of the color decision layer Hx is determined such that constructive interference occurs for the tight to be passed and destructive interference occurs for the light to be blocked.

When the total thickness of the color filter layer 310 is appropriately controlled, the color filer layer 310 may serve as an ARC layer, which corresponds to the component 205 of FIG. 2, preventing reflection of incident light. In an exemplary embodiment, the total thickness of the color filter layer 310 can be controlled by controlling the number of the first inorganic layers L and the second inorganic layers H that are alternately stacked.

According to an exemplary embodiment of the present invention, the color filter layer 310 is substantially thinner (e.g. about 0.3 μm or less) than the color filter layer 210 (of FIG. 2), having a thickness of about 0.5 μm or more, so that the color filter 310 can be formed into a complicated pattern.

The color filter layer 310 according to an exemplary embodiment of the present invention can be a multi-layered structure to narrow the pass band (the wavelength band of light that may pass through the color filter layer 310). Thus, the wavelength selectivity of the color filter 310 improves. That is, the pass band of the color filter layer 310 having a multi-layered structure is narrower than that of the color filter layer 210 (of FIG. 2) having a single-layered structure. Thus the wavelength selectivity of the color filter layer 310 is improved when the multi-layered structure is used. The enhancement of the wavelength selectivity is shown in connection with FIGS. 4 through 7. In FIGS. 4 through 7, a horizontal axis represents the wavelength of light (in units of nm) and a vertical axis represents relative transmittance of light by the color filter layer 310.

FIG. 4 shows a table for illustrating a relation between a thickness and a refractive index of each layer, and a graph for illustrating a relation between a wavelength and transmittance when the color filter layer 310 of FIG. 3 is a red color filter layer according to an exemplary embodiment of the present invention.

FIG. 4 shows an exemplary embodiment where the refractive index of the silicon substrate is 4.24, the refractive index of each of the first inorganic layers Lb and L is 1.45, the refractive index of each of the second inorganic layers H and Hx is 4.00, and the refractive index of the interlayer insulation layer is 1.45.

In this exemplary embodiment, the thickness of the fixed thickness first inorganic layer Lb is 700 Å, the thickness of each of the fixed thickness first inorganic layers L is 150 Å, the thickness of each of the fixed thickness second inorganic layers H is 460 Å, and the thickness of the color decision second inorganic layer Hx is 460 Å.

When the thickness of the color decision layer Hx is 460 Å, the color filter layer 310 selectively passes light of the red wavelength region. Here, the selective passing of light is defined as when the relative transmittance of the color filter layer 310 is greater than 1/√2, which corresponds to −3 dB.

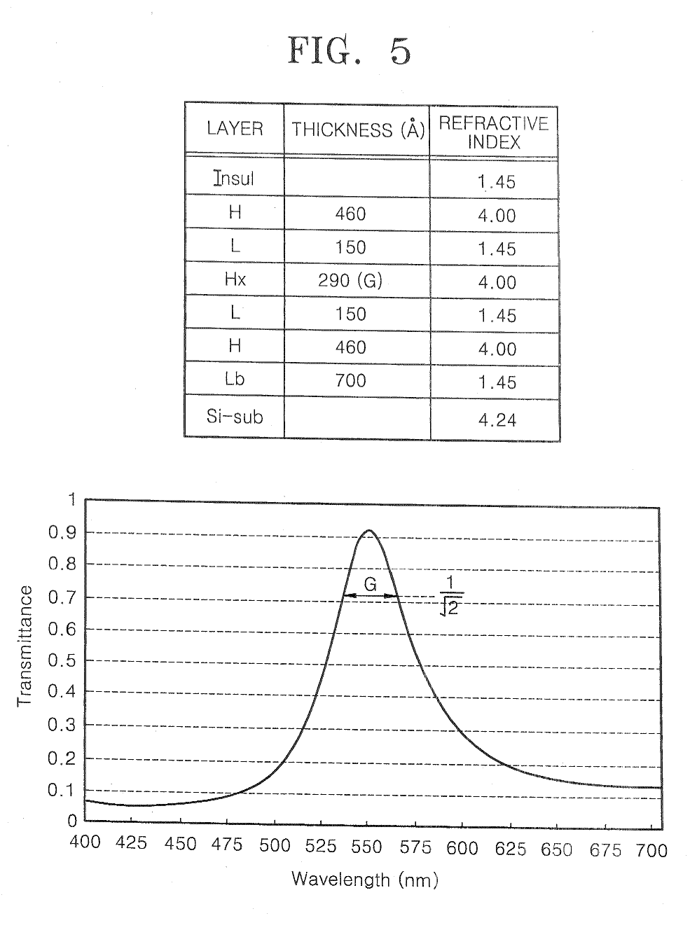

FIG. 5 shows a table for illustrating a relation between a thickness and a refractive index for each layer, and a graph for illustrating a relation between a wavelength and transmittance when the color filter layer of FIG. 3 is a green color filter layer according to an exemplary embodiment of the present invention. In this exemplary embodiment, the refractive index of the silicon substrate is 4.24, the refractive index of each of the first inorganic layers Lb and L is 1.45, the refractive index of each of the second inorganic layers H and Hx is 4.00, and the refractive index of the interlayer insulation layer is 1.45.

In this exemplary embodiment, the thickness of the fixed thickness first inorganic layer Lb is 700 Å, the thickness of each of the fixed thickness first inorganic layers L is 150 Å, the thickness of each of the fixed thickness second inorganic layers H is 460 Å, and the thickness of the color decision second inorganic layer Hx is 290 Å.

When the thickness of the color decision layer Hx is 290 Å, the color filter layer 310 selectively passes light of the green wavelength region.

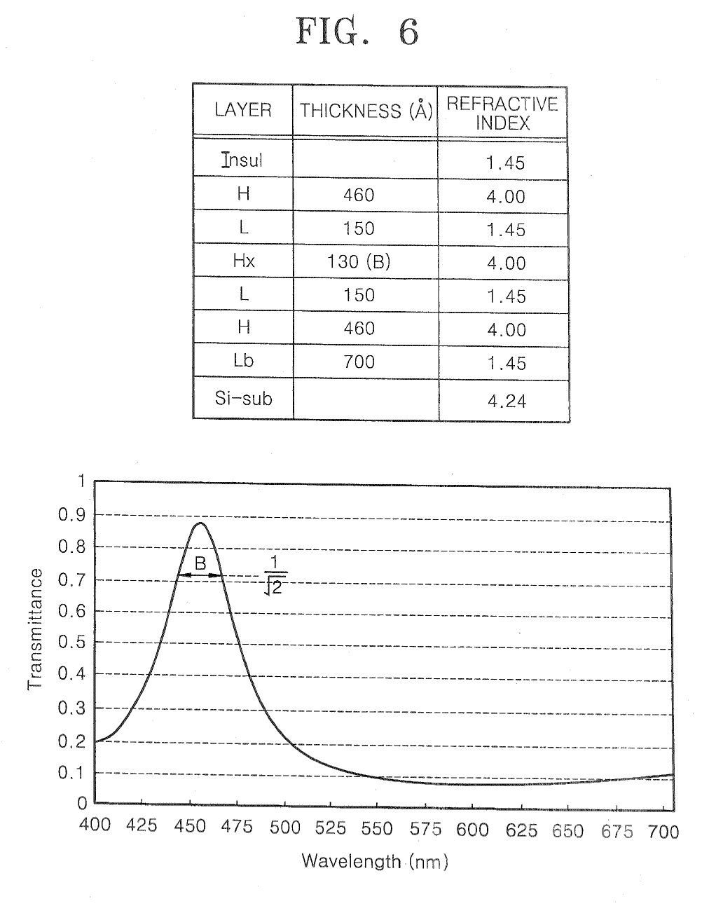

FIG. 6 shows a table for illustrating a relation between a thickness and a refractive index of each layer, and a graph for illustrating a relation between a wavelength and transmittance when the color filter layer 310 of FIG. 3 is a blue color filter layer according to an exemplary embodiment of the present invention.

In this exemplary embodiment, the refractive index of the silicon substrate is 4.24, the refractive index of each of the first inorganic layers Lb and L is 1.45, the refractive index of each of the second inorganic layers H and Hx is 4.00, and the refractive index of the interlayer insulation layer is 1.45.

The thickness of the fixed thickness first inorganic layer Lb is 700 Å, the thickness of each of the fixed thickness first inorganic layers L is 150 Å, the thickness of each of the fixed thickness second inorganic layers H is 460 Å, and the thickness of the color decision second inorganic layer Hx is 130 Å.

When the thickness of the color decision layer Hx is 130 Å, the color filter layer 310 selectively passes light of the blue wavelength region.

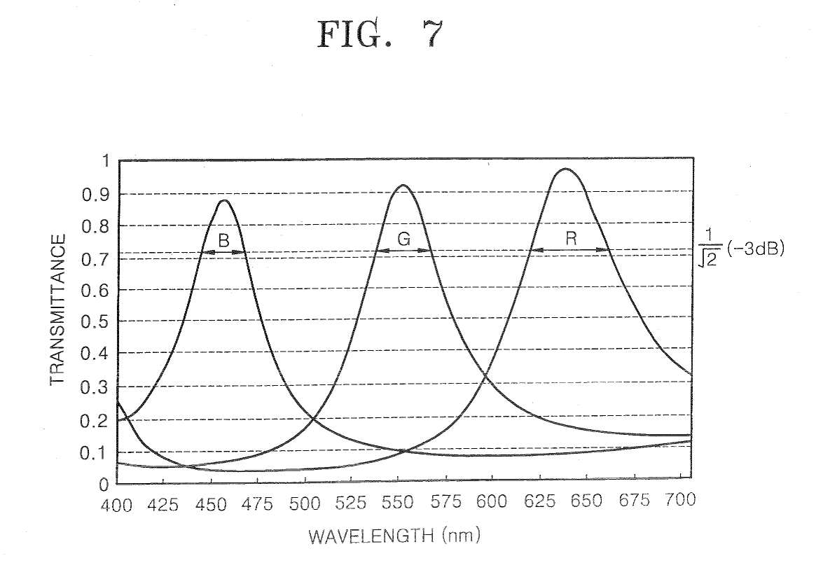

FIG. 7 is a graph showing a relation between a wavelength and transmittance according to an exemplary embodiment of the present invention.

Referring to FIG. 7, the color filter layer 310 according to an exemplary embodiment of the present invention can be a red color filter layer, a green color filter layer, or a blue color filter layer depending on the thickness of the color decision layer Hx (of FIG. 3).

The color filter layer 310 illustrated in FIG. 3 may be formed using the conditions illustrated in FIGS. 4 through 6. Light of the red wavelength region passes through the color filter layer 310 when the thickness of the color decision layer Hx is 460 Å. Light of the green wavelength region passes through the color filter layer 310 when the thickness of the color decision layer Hx is 290 Å. Light of the blue wavelength region passes through the color filter layer 310 when the thickness of the color decision layer Hx is 130 Å. Therefore, the color filter layer 310 according to an exemplary embodiment of the present invention may be a band pass filter, where the pass band is determined depending on the thickness of the color decision layer Hx.

The color filter layer 310 according to an exemplary embodiment of the present invention is not limited to the values used in connection with FIGS. 4 through 6, and may have a variety of exemplary embodiments.

The color filter layer 310 according to an exemplary embodiment of the present invention may be applied to an image sensing device such as a CIS. The image sensing device according to an exemplary embodiment of the present invention includes the microlens 309 (of FIG. 3) for condensing incident light, the color filer layer 310 selectively passing light of a particular wavelength band, and the photodiode 304 generating photo charge that corresponds to the amount of incident light.

In an exemplary embodiment of the present invention, the color filter layer 310 is formed by alternately stacking the first inorganic layers L and the second inorganic layers H each having a higher refractive index than that of the first inorganic layers L, on the region where the photodiode 304 is formed. The color filter layer 310 includes the fixed thickness layers Lb, L, and H each having a fixed thickness, and the color decision layer Hx having a thickness determined according to the wavelength of light to be passed. As described above, the pass band of the color filter layer 310 is determined depending on the thickness of the color decision layer Hx.

A method according to an exemplary embodiment of the present invention is described below.

An exemplary embodiment of the present invention provides a method of forming the color filter layer 310 (of FIG. 3) of an image sensing device such as a CIS, by stacking the first inorganic layers Lb and L (of FIG. 3) and the second inorganic layers H and Hx (of FIG. 3). Each second inorganic layer H, Hx has a higher refractive index than that of the first inorganic layers L and Lb.

Referring to FIG. 3, the first inorganic layer Lb having a fixed thickness regardless of the wavelength band of light to be passed is stacked on a photodiode formed on a silicon substrate.

The second inorganic layer H having a fixed thickness regardless of the wavelength of light to be passed is stacked, and then the first inorganic layer L having a fixed thickness regardless of the wavelength of light to be passed is stacked.

The second inorganic layer Hx having a thickness determined according to the wavelength band of light to be passed is stacked. As described above, the pass band of the color filter layer 310 is determined depending on the thickness of the second inorganic layer Hx (i.e. the color decision layer).

Stacking the first inorganic layer L having the fixed thickness regardless of the wavelength band of light to be passed and stacking the second inorganic layer H having the fixed thickness regardless of the wavelength band of light to be passed are repeated.

Stacking the first inorganic layer L and the second inorganic layer H are repeated such that the color filter layer 310 has a thickness that prevents reflection of incident light.

Though the second inorganic layer Hx is used as the color decision layer in the above embodiment, the first inorganic layer Lx can alternatively be used as the color decision layer according to an exemplary embodiment of the present invention.

A method of forming the color decision layer using the first inorganic layer Lx includes stacking the first inorganic layer L having a fixed thickness regardless of the wavelength band of light to be passed and stacking the second inorganic layer H having a fixed thickness regardless of the wavelength band of tight to be passed.

The method includes stacking a first inorganic layer Lx having a thickness determined according to the wavelength band of light to be passed. The pass band of the color filter layer 310 is determined depending on the thickness of the color decision layer formed of the first inorganic layer Lx.

Stacking the second inorganic layer H and stacking the first inorganic layer L are repeated such that the color fitter layer 310 has a thickness that prevents reflection of incident light.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A color filter layer for use in an image sensing device, the color filter layer comprising:
first inorganic layers, each first inorganic layer having a first refractive index; and
second inorganic layers, each second inorganic layer having a second refractive index,
wherein the second refractive index is higher than the first refractive index,
wherein the first and second inorganic layers are stacked on an optical sensor provided in the image sensing device to form a multi-layer, and
the multi-layer includes fixed thickness layers each having a fixed thickness and a color decision layer having a thickness determined according to a wavelength band of light to be passed.

2. The color filter layer of claim 1, wherein the multi-layer selectively passes light in a particular wavelength band according to the color decision layer, and blocks light other than light having the particular wavelength band.

3. The color filter layer of claim 2, wherein the light in the particular wavelength band is one of red, green, and blue light.

4. The color filter layer of claim 1, wherein the color decision layer is one of the second inorganic layers provided in the multi-layer.

5. The color filter layer of claim 4, wherein the multi-layer comprises fixed thickness layers which are the first inorganic layers, the color decision layer which is one of the second inorganic layers, and fixed thickness layers which are the second inorganic layers other than the color decision layer.

6. The color filter layer of claim 1, wherein the color decision layer is one of the first inorganic layers provided in the multi-layer.

7. The color filter layer of claim 6, wherein the multi-layer comprises the color decision layer which is one of the first inorganic layers, fixed thickness layers which are the first inorganic layers other than the color decision layer, and fixed thickness layers which are the second inorganic layers.

8. The color filter layer of claim 1, wherein the first inorganic layers and the second inorganic layers are alternately stacked on the optical sensor to form the multi-layer.

9. The color filter layer of claim 8, wherein the first inorganic layers and the second inorganic layers are sequentially stacked starting from one of the first inorganic layers on the optical sensor.

10. The color filter layer of claim 8, wherein the first inorganic layers and the second inorganic layers are sequentially stacked starting from one of the second inorganic layers on the optical sensor.

11. The color filter layer of claim 1, wherein a total thickness of the multi-layer is determined such that the multi-layer serves as an antireflection coating layer preventing reflection of incident light.

12. The color filter layer of claim 1, wherein the optical sensor comprises a photodiode.

13. The color filter layer of claim 1, wherein the image sensing device comprises a CMOS image sensor.

14. An image sensing device comprising:
a microlens condensing incident light;
a color filter layer for selectively passing tight in a particular wavelength band; and
a photodiode generating photo charge that corresponds to an amount of incident light,
wherein the color filter layer is formed by alternately stacking first inorganic layers and second inorganic layers on a region where the photodiode is formed, each first inorganic layer having a first refractive index and each second inorganic layer having a second refractive index, wherein the second refractive index is higher than the first refractive index,
wherein the color filter layer includes fixed thickness layers each having a fixed thickness and a color decision layer having a thickness determined according to the wavelength band of light to be passed.

15. The image sensing device of claim 14, wherein the color decision layer is one of the second inorganic layers provided in the color filter layer.

16. The image sensing device of claim 15, wherein the color filter layer comprises fixed thickness layers which are the first inorganic layers, the color decision layer which is one of the second inorganic layers and fixed thickness layers which are the second inorganic layers other than the color decision layer.

17. The image sensing device of claim 14, wherein the color decision layer is one of the first inorganic layers provided in the color filter layer.

18. The image sensing device of claim 17, wherein the color filter layer comprises the color decision layer which is one of the first inorganic layers, fixed thickness layers which are the first inorganic layers other than the color decision layer, and fixed thickness layers which are the second inorganic layers.

19. The image sensing device of claim 14, wherein the total thickness of the color filter layer is determined such that the color fitter layer serves as an antireflection coating layer preventing reflection of incident light.

20. A method of forming a color filter layer of an image sensing device, the method comprising:
stacking a second inorganic layer having a thickness determined according to a wavelength band of light to be passed;
stacking a first inorganic layer having a fixed thickness regardless of the wavelength band of light to be passed; and
stacking a second inorganic layer having a fixed thickness regardless of the wavelength band of light to be passed,
wherein the color filter layer is formed on a photodiode formed on a silicon substrate, and each second inorganic layer has a higher refractive index than that of each first inorganic layer.

21. The method of claim 20, wherein the total thickness of the color fitter layer is determined such that the color filter layer serves as an antireflection coating layer preventing reflection of incident light.

22. A method of forming a color fitter layer of an image sensing device, the method comprising:
stacking a first inorganic layer having a fixed thickness regardless of a wavelength band of light to be passed;
stacking a second inorganic layer having a fixed thickness regardless of the wavelength band of light to be passed; and
stacking a first inorganic layer having a thickness determined according to the wavelength band of light to be passed,
wherein the color filter layer is formed on a photodiode formed on a silicon substrate, and each second inorganic layer has a higher refractive index than that of each first inorganic layer.

23. The method of claim 22, wherein the total thickness of the color filter layer is determined such that the color filter layer serves as an antireflection coating layer preventing reflection of incident light.
